(19) United States
(12) Patent Application Publication
(10) Pub. No.: US 2018/0181386 A1
(43) Pub. Date: Jun. 28, 2018

(54) INFORMATION PROCESSING SYSTEM, INFORMATION PROCESSING METHOD, AND COMPUTER PROGRAM PRODUCT

(71) Applicant: Noriyuki UEHARA, Kanagawa (JP)

(72) Inventor: Noriyuki UEHARA, Kanagawa (JP)

(73) Assignee: Ricoh Company, Ltd., Tokyo (JP)

(21) Appl. No.: 15/848,438

(22) Filed: Dec. 20, 2017

(30) Foreign Application Priority Data
Dec. 26, 2016 (JP) 2016-251727

(51) Int. Cl. G06F 8/65; G06F 11/14; G06F 9/44

(52) U.S. Cl. CPC G06F 8/65; G06F 9/442; G06F 11/1433

(57) ABSTRACT

An information processing system includes a first information processing device and a second information processing device communicatively connected to the first information processing device. The first information processing device includes an update processing unit and a first shutdown processing unit. The second information processing device includes an update request unit to request the update processing unit to perform updating of software, an error detection unit to detect an error during the updating, a second shutdown processing unit to perform shutting down of the second information processing device, a shutdown request unit to request the first shutdown processing unit and the second shutdown processing unit to perform the shutting down in response to a detection of the error with the error detection unit, and a startup unit to start up the second information processing device at a predetermined time after the shutting down of the second information processing device.

### CROSS-REFERENCE TO RELATED APPLICATION

This patent application is based on and claims priority pursuant to 35 U.S.C. § 119(a) to Japanese Patent Application No. 2016-251727, filed on Dec. 26, 2016, in the Japan Patent Office, the entire disclosure of which is hereby incorporated by reference herein.

### BACKGROUND

### Technical Field

Aspects of the present disclosure relates to an information processing system, an information processing method, and a computer program product.

### Related Art

A method for remotely updating firmware of a multi-function peripheral (MFP) is conventionally known. However, due to unattended environment, this method may be unable to solve a problem (error) that has occurred during firmware update processing, and may thus cause the MFP to be inoperative for a relatively long time. To address this disadvantage, a method is suggested to restore the firmware being updated to the firmware before the update to recover failure of update processing if an error occurs during firmware update processing.

### SUMMARY

In an aspect of the present disclosure, there is provided an information processing system that includes a first information processing device and a second information processing device communicatively connected to the first information processing device. The first information processing device includes an update processing unit to perform updating of software and a first shutdown processing unit to perform shutting down of the first information processing device. The second information processing device includes an update request unit to request the update processing unit to perform the updating, an error detection unit to detect an error during the updating, a second shutdown processing unit to perform shutting down of the second information processing device, a shutdown request unit to request the first shutdown processing unit and the second shutdown processing unit to perform the shutting down in response to a detection of the error with the error detection unit, and a startup unit to start up the second information processing device at a predetermined time after the shutting down of the second information processing device.

In another aspect of the present disclosure, there is provided an information processing method performed by a second information processing device communicatively connected to a first information processing device. The method includes requesting the first information processing device to perform updating of software, detecting an error during the updating, requesting the first information processing device to perform shutting down in response to a detection of the error during the updating, shutting down the second information processing device, and starting up the second information processing device at a predetermined time after the shutting down of the second information processing device.

In another aspect of the present disclosure, there is provided a computer program product that includes a non-transitory computer-readable medium containing program code. The program code causes a second information processing device communicatively connected to a first information processing device to perform: requesting the first information processing device to perform updating of software; detecting an error during the updating; requesting the first information processing device to perform shutting down in response to a detection of the error during the updating; shutting down the second information processing device; and starting up the second information processing device at a predetermined time after the shutting down of the second information processing device.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a system configuration of an MFP as an information processing system according to a first embodiment of the present disclosure;

FIG. 2 is a block diagram illustrating an example of a hardware configuration of an operation panel in the first embodiment;

FIG. 3 is a block diagram illustrating an example of a hardware configuration of a controller in the first embodiment;

FIG. 4 is a block diagram illustrating an example of a functional configuration of the MFP in the first embodiment;

FIG. 5 is an example of a screen view displayed on a display device of the operation panel;

FIG. 6 is a sequence chart illustrating an example of a process in a case in which no error occurs during updating of firmware;

FIG. 7 is a sequence chart illustrating an example of a process in a case in which an error occurs during updating of firmware;

FIG. 8 is a block diagram illustrating an example of a hardware configuration of an operation panel in the MFP as the information processing system according to a second embodiment of the present disclosure;

FIG. 9 is a block diagram illustrating an example of a functional configuration of the MFP in the second embodiment;

FIG. 10 is a sequence chart illustrating an example of a process in a case in which an error occurs during updating of firmware in the second embodiment; and

FIG. 11 is a flowchart illustrating an example of a process performed by a controller in a third embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure will be described below with reference to the accompanying drawings. Like reference characters refer to like components having substantially the same functional configuration in the specification and in the drawings throughout the disclosed embodiments, and redundant explanation of these components will be omitted.

### First Embodiment

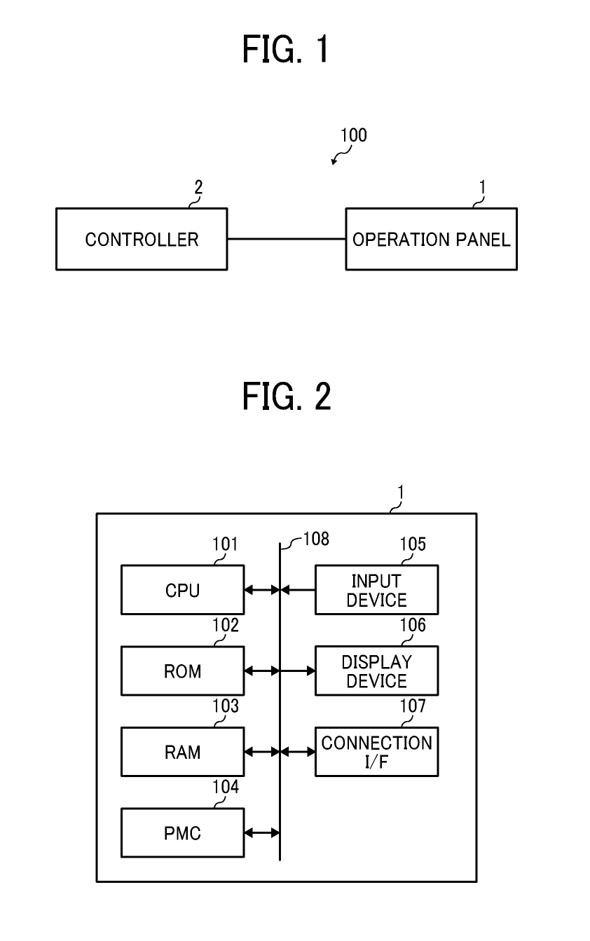

An information processing system according to a first embodiment will be described below referring to FIGS. 1 to 7. The information processing system according to this embodiment may be any system including two information processing devices communicatively connected to each other. The information processing system may be, for example, an MFP, a printing apparatus, a scanning apparatus, a facsimile machine, an interactive whiteboard, a projector, or a digital camera, but is not limited to these items. The description given below assumes that the information processing system is an MFP.

The configuration of an MFP 100 as the information processing system according to this embodiment will first be described.

FIG. 1 illustrates an example of the system configuration of the MFP 100 as the information processing system according to this embodiment. The MFP 100 of FIG. 1 includes an operation panel 1 and a controller 2.

The operation panel 1 (first information processing device) is an input/output device of the MFP 100. The operation panel 1 provides a user interface (UI) that allows a user to operate the MFP 100. The operation panel 1 is communicatively connected to the controller 2 via a bus, such as a PCI Express bus or a Universal Serial Bus (USB) bus.

The controller 2 (second information processing device) controls the entire MFP 100, and is communicatively connected to the operation panel 1 via a bus, such as a PCI Express bus or a USB bus. Although FIG. 1 illustrates the controller 2 as being connected only with the operation panel 1, other components (e.g., printing apparatus, scanning apparatus, and handling apparatus) that may be included in the MFP may also be connected to the controller 2.

The hardware configuration of the MFP 100 as the information processing system according to this embodiment will next be described.

FIG. 2 illustrates an example of the hardware configuration of the operation panel 1 according to this embodiment. The operation panel 1 of FIG. 2 includes a central processing unit (CPU) 101, a read only memory (ROM) 102, a random access memory (RAM) 103, and a power management controller (PMC) 104. The operation panel 1 also includes an input device 105, a display device 106, a connection interface (I/F) 107, and a bus 108.

The CPU 101 executes one or more programs to control other components in the operation panel 1 to provide functions of the operation panel 1. The ROM 102 is a data rewritable ROM (e.g., flash memory). The ROM 102 stores one or more programs executed by the CPU 101, and various data including configuration data, and also stores firmware of the operation panel 1, a program for updating the firmware, and the operating system (OS) of the operation panel 1. The RAM 103 provides a workspace for the CPU 101. The PMC 104 is, for example, a microcomputer. The PMC 104 manages power supply to the operation panel 1. The input device 105 detects a user action, and inputs various information to the operation panel 1. The input device 105 is, for example, a mouse, a keyboard, a touch panel, one or more hardware keys, or a combination thereof. The display device 106 displays various information held in the operation panel 1. The display device 106 is, for example, a liquid crystal display or an organic electroluminescence (EL) display. The connection I/F 107 is an interface for connecting the operation panel 1 to the controller 2 via a bus, such as a PCI Express bus or a USB bus. The operation panel 1 communicates with the controller 2 via the connection I/F 107. The bus 108 connects the CPU 101, the ROM 102, the RAM 103, the PMC 104, the input device 105, the display device 106, and the connection I/F 107 to one another.

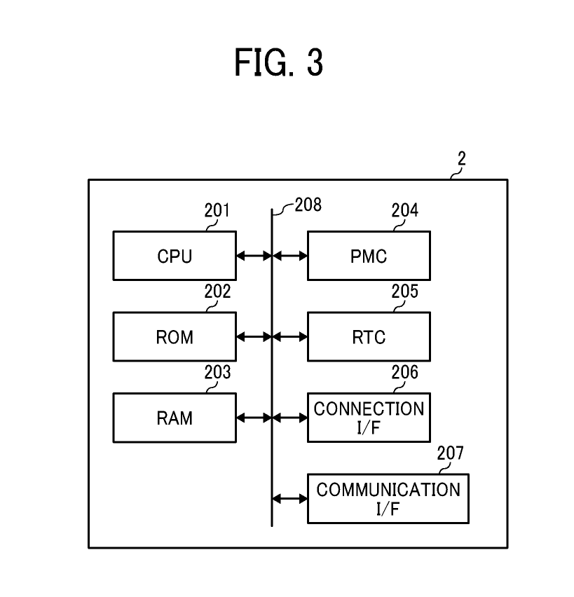

FIG. 3 illustrates an example of the hardware configuration of the controller 2. The controller 2 of FIG. 3 includes a CPU 201, a ROM 202, a RAM 203, a PMC 204, a real time clock (RTC) 205, a connection I/F 206, a communication I/F 207, and a bus 208.

The CPU 201 executes one or more programs to control other components in the controller 2 to provide functions of the controller 2. The ROM 202 stores one or more programs executed by the CPU 201, and various data including configuration data. The ROM 202 also stores the OS of the controller 2, and a program for updating the firmware of the operation panel 1. The RAM 203 provides a workspace for the CPU 201. The PMC 204 is, for example, a microcomputer. The PMC 204 manages power supply to the controller 2. The RTC 205 is an integrated circuit (IC) for determining a time duration. The RTC 205 operates continuously, and is powered by an internal battery while the controller 2 is powered off. The connection I/F 206 is an interface for connecting the controller 2 to the operation panel 1 via a bus, such as a PCI Express bus or a USB bus. The controller 2 communicates with the operation panel 1 via the connection I/F 206. The communication I/F 207 is an interface for connecting the controller 2 to a network, such as a local area network (LAN) or the Internet. The controller 2 communicates with an external device via the communication I/F 207. For example, the controller 2 receives a new piece of the firmware for the operation panel 1 from a management server of the MFP 100, via the communication I/F 207. The bus 208 connects the CPU 201, the ROM 202, the RAM 203, the PMC 204, the RTC 205, the connection I/F 206, and the communication I/F 207 to one another.

The functional configuration of the MFP 100 as the information processing system according to this embodiment will next be described.

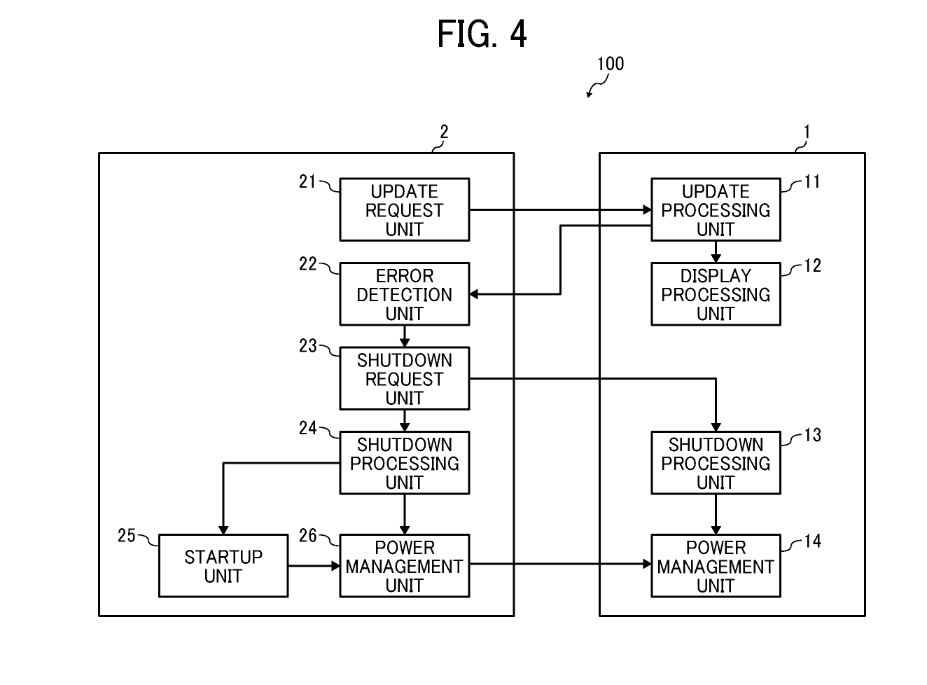

FIG. 4 illustrates an example of the functional configuration of the MFP 100 in this embodiment. The functional configurations of the operation panel 1 and of the controller 2 will be described below.

The functional configuration of the operation panel 1 will first be described. The operation panel 1 of FIG. 4 includes an update processing unit 11, a display processing unit 12, a shutdown processing unit 13, and a power management unit 14.

The update processing unit 11 performs processing to update software of the operation panel 1. Although the description of this embodiment assumes that the update processing unit 11 updates the firmware of the operation panel 1, the update processing unit 11 may additionally or alternatively update the OS, an application program, or both, of the operation panel 1. The functions of the update processing unit 11 are implemented by execution, by the CPU 101, of a program associated with the function.

The display processing unit 12 causes the display device 106 to display screens, such as a home screen and a configuration screen. The home screen allows a user to select a function of the MFP 100 (e.g., printer function or scanner function). The configuration screen allows a user to set a setting value to be applied when the user uses an associated function. The display processing unit 12 also causes the display device 106 to display, during updating of the firmware of the operation panel 1, a message informing the user that firmware update processing is in progress.

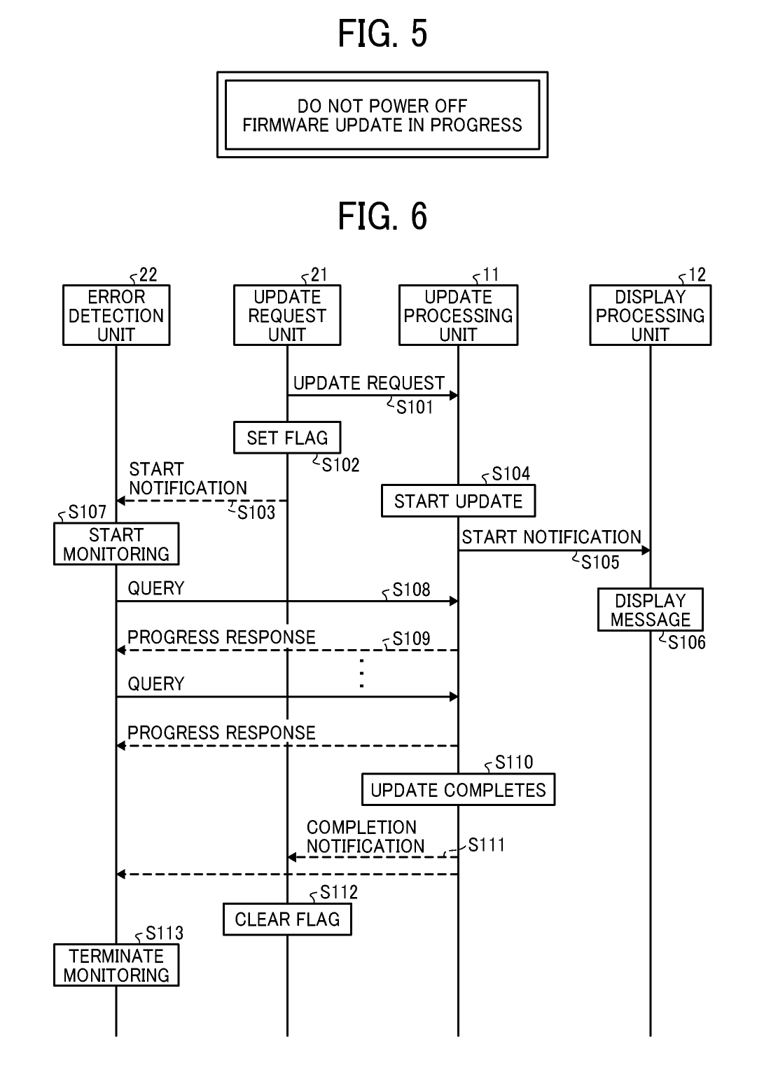

FIG. 5 illustrates an example of a screen displayed on the display device 106. The screen of FIG. 5 is displaying a message saying “Do not power off. Firmware update in progress.” Displaying such a screen during updating of the firmware can prevent the user from powering off the MFP 100 during updating of the firmware. The functions of the display processing unit 12 are implemented by execution, by the CPU 101, of a program associated with the function.

The shutdown processing unit 13 (first shutdown processing unit) performs processing to shut down the operation panel 1 in response to a shutdown request from the controller 2. This function of the shutdown processing unit 13 is implemented by the CPU 101 operating the OS of the operation panel 1.

The power management unit 14 manages power supply to the operation panel 1. Specifically, the power management unit 14 manages a power-on operation of the operation panel 1 (ON) and a power-off operation of the operation panel 1 (OFF). The functions of the power management unit 14 are provided by the PMC 104.

The functional configuration of the controller 2 will next be described. The controller 2 of FIG. 4 includes an update request unit 21, an error detection unit 22, a shutdown request unit 23, a shutdown processing unit 24, a startup unit 25, and a power management unit 26.

Upon receiving a new piece of firmware for the operation panel 1 from an external device, such as a server, the update request unit 21 transfers that piece of firmware to the operation panel 1, and requests the update processing unit 11 to update the firmware. The update request unit 21 may receive the difference from the original firmware before update rather than a new piece of firmware. The functions of the update request unit 21 are implemented by execution, by the CPU 201, of a program associated with the function.

When updating of the firmware of the operation panel 1 begins, the error detection unit 22 starts monitoring of whether the update processing is proceeding normally, to detect an error in the operation panel 1 during the update processing. The method for detecting an error may be any existing method. For example, the error detection unit 22 may receive an error notification from the update processing unit 11. Additionally or alternatively, the error detection unit 22 may periodically sends a query about the progress of the update processing to the update processing unit 11. In this case, the error detection unit 22 may determine that an error has occurred during updating (during performance of update processing) of the firmware if no response is received for the query, or if the update processing does not progress for a preset first wait time (e.g., 30 minutes) or more. The first wait time may be set to any value, but is preferably set to a value longer than or equal to the time required for the update processing to complete. The purpose for this is to prevent false error detection in a case of temporary suspension of the update processing. Thus, use of a first wait time enables the error detection unit 22 to correctly detect an occurrence of an error during updating of the firmware. The functions of the error detection unit 22 are implemented by execution, by the CPU 201, of a program associated with the function.

The shutdown request unit 23 requests the shutdown processing unit 13 to perform processing to shut down the operation panel 1 when an error that has occurred during updating of the firmware is detected by the error detection unit 22. The shutdown request unit 23 also requests the shutdown processing unit 24 to perform processing to shut down the controller 2 when an error that has occurred during updating of the firmware is detected by the error detection unit 22. In other words, in this embodiment, detection of an error during updating of the firmware causes both the operation panel 1 and the controller 2 to be shut down. The functions of the shutdown request unit 23 are implemented by execution, by the CPU 201, of a program associated with the function.

The shutdown processing unit 24 (second shutdown processing unit) performs processing to shut down the controller 2 in response to a shutdown request from the shutdown request unit 23. This function of the shutdown processing unit 24 is implemented by the CPU 201 operating the OS of the controller 2.

The startup unit 25 starts up the controller 2 at a predetermined time after the controller 2 is shut down. The functions of the startup unit 25 are implemented by the RTC 205. Upon the startup, the controller 2 starts up the operation panel 1. Thus, it is intended in this embodiment that use of the foregoing method solve an error in update processing by restart of the MFP 100. Reasons for restarting the MFP 100 in the foregoing manner are as follows.

If the MFP 100 is restarted using a normal restart process performed by each OS, the controller 2 needs to request the operation panel 1 to perform a preliminary process specific to the restart process (e.g., a process to reduce the startup time upon restarting). However, since the operation panel 1 is under some fault condition when the preliminary process is requested, the controller 2 may receive no response to the request from the operation panel 1. In addition, the request for the preliminary process may induce an unexpected operation in the operation panel 1. Furthermore, the normal restart process, which does not clear the RAMs 103 and 203 of the operation panel 1 and of the controller 2, may allow the data that has caused the error to be left as it is in the RAMs 103 and 203.

In any of these cases, the normal restart process may hinder or prevent error resolution utilizing restart of the MFP 100. Therefore, this embodiment uses the foregoing method, rather than the normal restart process, to restart the MFP 100. Restart of the MFP 100 using the method of restarting according to this embodiment can prevent a delay of response and unnecessary processing by the operation panel 1. In addition, clearing of the RAMs 103 and 203 of the operation panel 1 and of the controller 2 can prevent unwanted data from being left in the RAMs 103 and 203.

The power management unit 26 manages power supply to the controller 2. Specifically, the power management unit 26 manages a power-on operation of the controller 2 and a power-off operation of the controller 2. The functions of the power management unit 26 are provided by the PMC 204.

The firmware update processing in this embodiment will next be described.

FIG. 6 is a sequence chart illustrating an example of a process in a case in which no error occurs during updating of the firmware. The process of FIG. 6 is triggered to start by an event in which the update request unit 21 receives a new piece of firmware of the operation panel 1 from an external server.

First, at step S101, the update request unit 21 transfers the new piece of firmware to the update processing unit 11, and requests the update processing unit 11 to update the firmware. At step S102, the update request unit 21 sets a flag indicating that update processing is in progress (hereinafter referred to as “update in-progress flag”). The update in-progress flag is stored in the ROM 102. At step S103, the update request unit 21 informs the error detection unit 22 of the start of updating of the firmware.

After receiving the request for updating of the firmware, at step S104, the update processing unit 11 starts firmware update processing. At step S105, the update processing unit 11 informs the display processing unit 12 of the start of updating of the firmware. When informed of the start of updating of the firmware, at step S106, the display processing unit 12 causes the display device 106 to display a message indicating that firmware update processing is in progress. Thus, a screen such as one illustrated in FIG. 5 is displayed on the display device 106.

In addition, when informed of the start of updating of the firmware, at step S107, the error detection unit 22 starts monitoring of the update processing. First, at step S108, the error detection unit 22 sends a query about the progress of the update processing to the update processing unit 11. Upon receiving the query for the progress, at step S109, the update processing unit 11 responds to the error detection unit 22 with current progress of the update processing. The error detection unit 22 checks this response to determine whether the update processing is proceeding normally. During the period of monitoring the update processing, the error detection unit 22 periodically repeats these steps of queries and responses.

When the firmware update processing completes at step S110, the update processing unit 11 informs, at step S11, the update request unit 21 and the error detection unit 22 of the completion of the firmware update processing. When informed of the completion of the firmware update processing, at step S112, the update request unit 21 clears the update in-progress flag. At step S113, the error detection unit 22 terminates monitoring of the update processing. The process described above allows the MFP 100 to perform updating of the firmware of the operation panel 1.

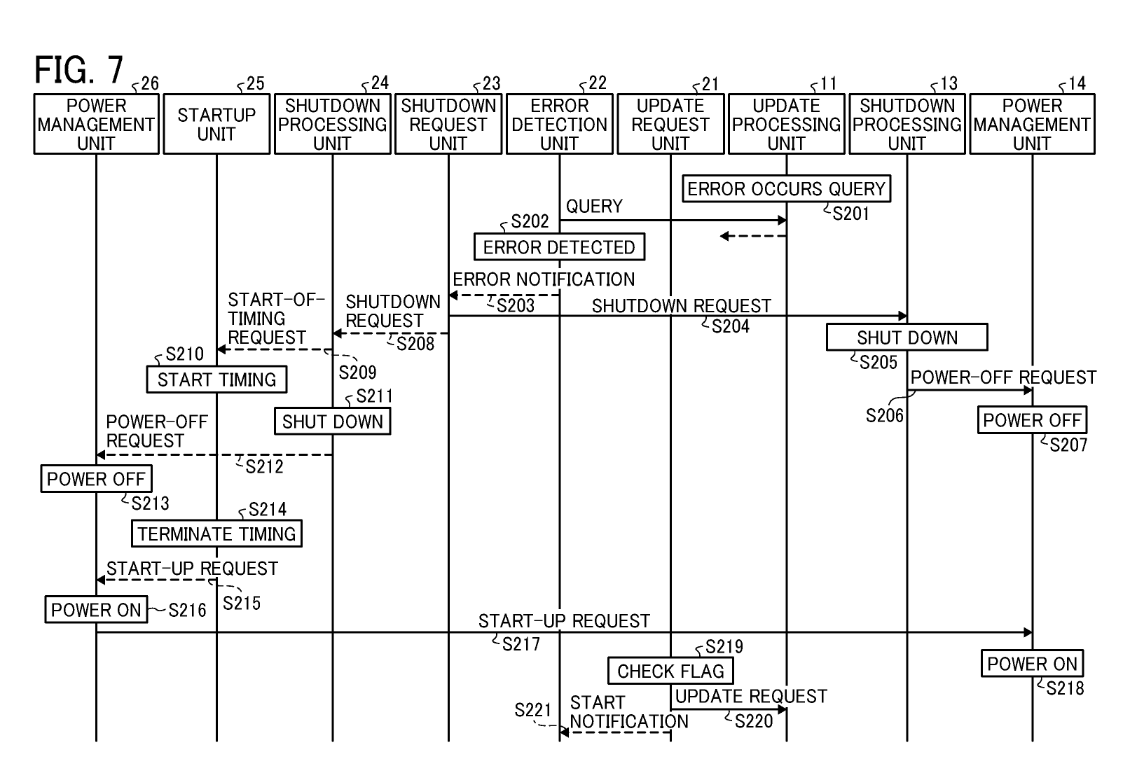

FIG. 7 is a sequence chart illustrating an example of a process in a case in which an error occurs during updating of the firmware. The process of FIG. 7 starts when firmware update processing is already in progress.

If an error occurs during updating of the firmware at step S201, the update processing unit 11 may fail to respond to a query from the error detection unit 22. If no response is received from the update processing unit 11, the error detection unit 22 determines that an error has occurred during updating of the firmware. That is, at step S202, the error detection unit 22 detects an error of the update processing. As described above, the error detection unit 22 may also determine that an error has occurred during updating of the firmware if the update processing does not progress for a first wait time or a longer time period. If the error detection unit 22 detects an error, the error detection unit 22 informs the shutdown request unit 23, at step S203, that an error has occurred during updating of the firmware.

When informed of an occurrence of the error, at step S204, the shutdown request unit 23 requests the shutdown processing unit 13 of the operation panel 1 to perform processing to shut down the operation panel 1. Upon receiving the shutdown request, the shutdown processing unit 13 performs processing to shut down the operation panel 1 at step S205. The shutdown processing includes saving data to the ROM 102.

When the shutdown processing completes, and the operation panel 1 is ready to be safely powered off, at step S206, the shutdown processing unit 13 requests the power management unit 14 to power off the operation panel 1. Upon receiving the power-off request, at step S207, the power management unit 14 powers off the operation panel 1. Thus, the operation panel 1 is shut down.

In addition, when informed of an occurrence of the error, at step S208, the shutdown request unit 23 informs the shutdown processing unit 24 of the controller 2 of the value of a second wait time (e.g., 5 minutes), and requests the shutdown processing unit 24 to perform processing to shut down the controller 2. As used herein, the second wait time is a time from when the startup unit 25 starts time measurement (timing) until the startup unit 25 requests starting up of the controller 2. The second wait time may be set to any value, but is preferably set to a value longer than or equal to the time required for the processing to shut down the controller 2 to complete. Such value ensures completion of shutdown of the controller 2.

Upon receiving the shutdown request, at step S209, the shutdown processing unit 24 sets, to the startup unit 25, the second wait time received from the shutdown request unit 23, and requests the startup unit 25 to start timing of the second wait time. Upon receiving the request for starting timing, at step S210, the startup unit 25 starts timing of the second wait time.

Upon receiving the shutdown request, the shutdown processing unit 24 performs processing to shut down the controller 2 at step S211. The shutdown processing includes saving data to the ROM 202.

When the shutdown processing completes, and the controller 2 is ready to be safely powered off, at step S212, shutdown processing unit 24 requests the power management unit 26 to power off the controller 2. Upon receiving the power-off request, at step S213, the power management unit 26 powers off the controller 2. Thus, the controller 2 is shut down. Even after the shutdown of the controller 2, the startup unit 25 continues to time the second wait time.

When the second wait time has elapsed since the start of timing of the second wait time, at step S214, the startup unit 25 terminates timing of the second wait time. At step S215, the startup unit 25 requests the power management unit 26 to start up the controller 2. Upon receiving the request for starting up the controller 2, at step S216, the power management unit 26 powers on the controller 2 to start up the controller 2.

When the power management unit 26 powers on the controller 2, at step S217, the power management unit 26 also requests the power management unit 14 to start up the operation panel 1. Upon receiving the request for starting up the operation panel 1, at step S218, the power management unit 14 powers on the operation panel 1 to start up the operation panel 1.

When the controller 2 starts up, at step S219, the update request unit 21 checks the status of the update in-progress flag, that is, whether the update in-progress flag is set. The update in-progress flag is set if the MFP 100 has been restarted because of an error occurred during updating of the firmware. The update in-progress flag is in a cleared state otherwise. Thus, the update request unit 21 can determine whether the firmware update processing has failed by checking the status of the update in-progress flag.

Since the example of FIG. 7 assumes that the update in-progress flag is set, the update request unit 21 determines that the firmware update processing has failed. At step S220, the update request unit 21 thus transfers a new piece of firmware to the update processing unit 11 for retrying the firmware update processing, and requests the update processing unit 11 to update the firmware. Besides, at step S221, the update request unit 21 informs the error detection unit 22 of the start of updating of the firmware. The process thereafter is similar to the process at and after step S104 of FIG. 6.

As described above, the MFP 100 according to this embodiment restarts and performs again the firmware update processing if an error occurs during updating of the firmware of the operation panel 1. Therefore, if restarting of the MFP 100 can solve the error that has occurred during updating of the firmware, the MFP 100 can automatically solve the error to successfully update the firmware. The MFP 100 according to this embodiment can solve an error of the operation panel 1 without attendance of an operator, and is thus suitably applicable as an MFP 100 whose firmware is remotely updated.

### Second Embodiment

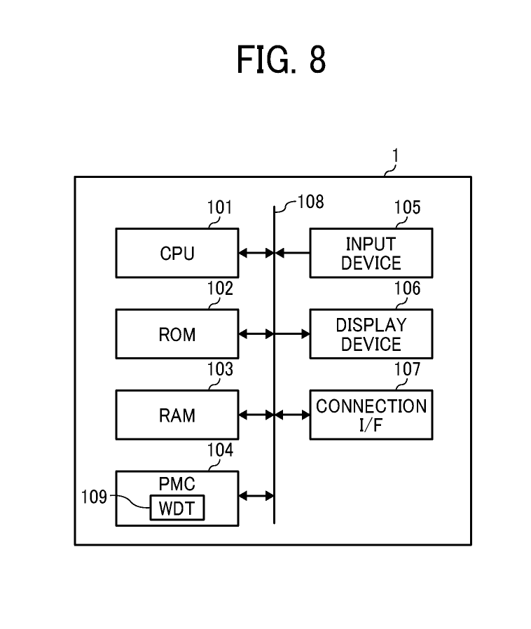

The MFP 100 as the information processing system according to a second embodiment of the present disclosure will next be described referring to FIGS. 8 to 10. When an error occurs during updating of the firmware, the error itself may prevent the shutdown processing unit 13 from shutting down the operation panel 1. If the processing to shut down the operation panel 1 is not performed, the MFP 100 in the first embodiment cannot shut down the operation panel 1, thereby failing to update the firmware. Thus, the MFP 100 in this embodiment is capable of updating the firmware even when the shutdown processing unit 13 cannot perform the processing to shut down the operation panel 1. The controller 2 of this embodiment is configured similarly to the controller 2 of the first embodiment.

The hardware configuration of the operation panel 1 according to this embodiment will first be described.

FIG. 8 illustrates an example of the hardware configuration of the operation panel 1 according to this embodiment. The operation panel 1 of FIG. 8 includes a watchdog timer (WDT) 109. The configuration of the other portion of the operation panel 1 according to this embodiment is similar to the corresponding configuration of the operation panel 1 according to the first embodiment.

The WDT 109 is an IC for determining a time duration. Although FIG. 8 illustrates the WDT 109 in the PMC 104, the WDT 109 may be provided separately.

The functional configuration of the operation panel 1 according to this embodiment will next be described.

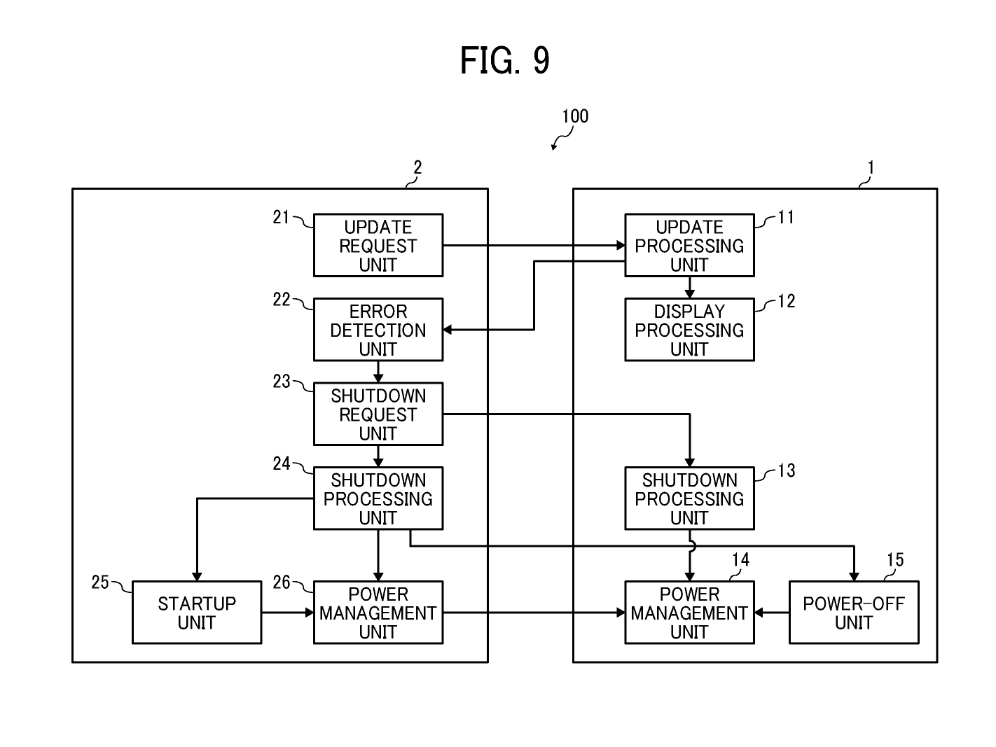

FIG. 9 illustrates an example of the functional configuration of the operation panel 1 according to this embodiment. The operation panel 1 of FIG. 9 includes a power-off unit 15. The configuration of the other portion of the operation panel 1 is similar to the corresponding configuration of the operation panel 1 according to the first embodiment.

The power-off unit 15 shuts down the operation panel 1 at a predetermined time after the shutdown processing unit 13 starts the processing to shut down the operation panel 1 irrespective of whether the shutdown processing is complete or not. The functions of the power-off unit 15 are implemented by the WDT 109.

The firmware update processing in this embodiment will next be described.

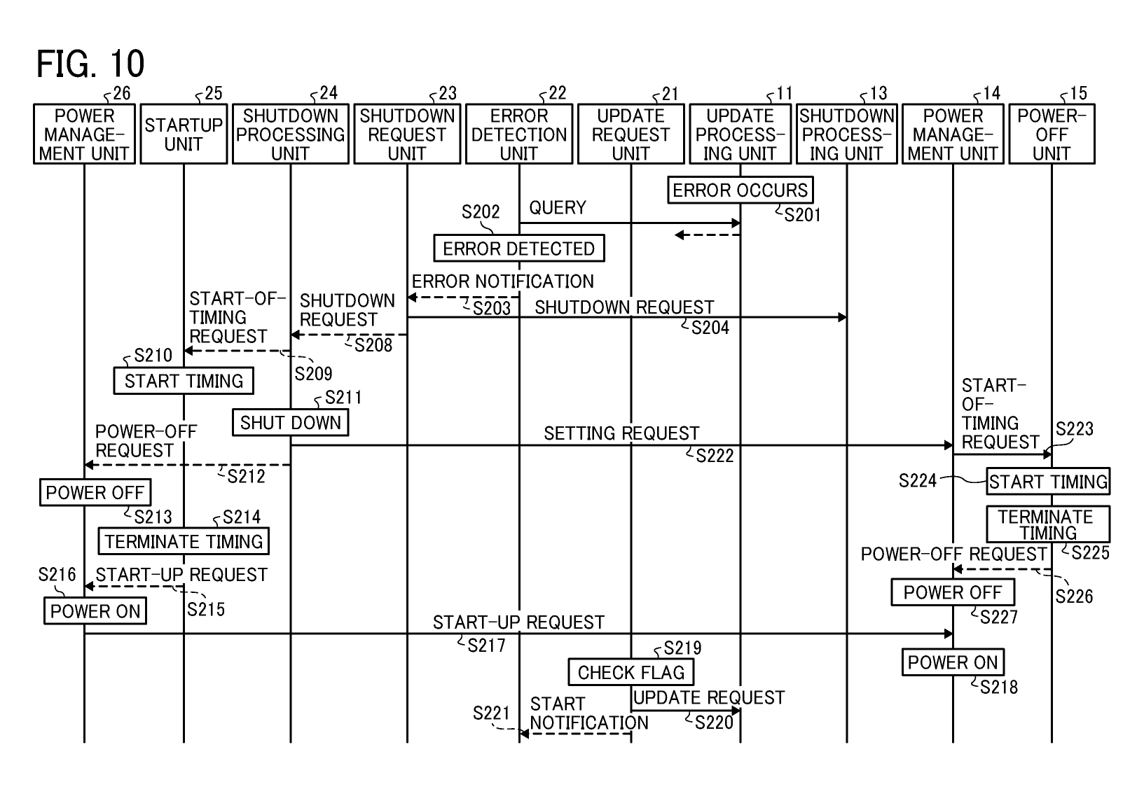

FIG. 10 is a sequence chart illustrating an example of a process in a case in which an error occurs during updating of the firmware according to the second embodiment. The sequence illustrated in FIG. 10 differs from the sequence illustrated in FIG. 7 in further including steps S222 to S227. Note that FIG. 10 assumes that the shutdown processing unit 13 of the operation panel 1 fails to perform the shutdown processing (step S205), and thus does not include steps S205 to S207. Thus, the description given below describes the process from step S222 to step S227.

In this embodiment, upon receiving the shutdown request, the shutdown processing unit 24 informs the power management unit 14 of the controller 2 of the value of a third wait time, and requests the power-off unit 15 to set that value as the third wait time. As used herein, the third wait time is a time from when the power-off unit 15 starts time measurement (timing) until the power-off unit 15 requests powering off of the operation panel 1. The third wait time may be set to any value, but is preferably set to a value longer than or equal to the time required for the processing to shut down the operation panel 1 to complete. Such value ensures completion of shutdown of the operation panel 1 if the shutdown processing unit 13 can perform the shutdown processing.

Upon receiving the request for setting the third wait time, at step S223, the power management unit 14 sets the third wait time to the power-off unit 15, and requests the power-off unit 15 to start timing of the third wait time. Note that this embodiment assumes that the WDT 109 is included in the PMC 104. Therefore, the shutdown processing unit 24 causes the power-off unit 15 to set the third wait time via the power management unit 14. However, if the WDT 109 is separately provided from the PMC 104, the shutdown processing unit 24 may sets the third wait time directly to the power-off unit 15, and request the power-off unit 15 to start timing of the third wait time.

Upon receiving the start-of-timing request, at step S224, the power-off unit 15 starts timing of the third wait time. When the third wait time has elapsed since the start of timing of the third wait time, and the power-off unit 15 terminates timing of the third wait time at step S225, the power-off unit 15 requests, at step S226, the power management unit 14 to power off the operation panel 1. Upon receiving the power-off request, at step S227, the power management unit 14 powers off the operation panel 1. Thus, the operation panel 1 is shut down.

As described above, the MFP 100 in this embodiment can successfully shut down the operation panel 1 even when the shutdown processing unit 13 of the operation panel 1 fails to perform the shutdown processing. Therefore, similarly to the first embodiment, if restarting of the MFP 100 can solve the error that has occurred during updating of the firmware, the MFP 100 can automatically solve the error to successfully update the firmware.

### Third Embodiment

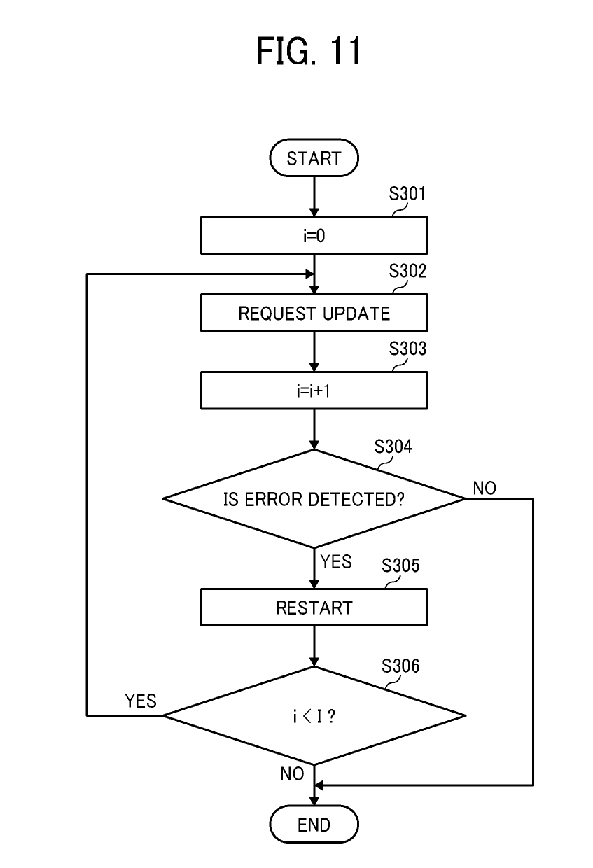

The MFP 100 as the information processing system according to a third embodiment of the present disclosure will next be described referring to FIG. 11. The MFP 100 of this embodiment has a maximum number I of consecutive firmware update requests. The configurations of the operation panel 1 and of the controller 2 according to this embodiment are similar to the configurations of these components of the first embodiment.

FIG. 11 is a flowchart illustrating an example of a process performed by the controller 2 according to this embodiment. The process of FIG. 11 begins when the update request unit 21 receives a new piece of firmware of the operation panel 1 from an external server.

First, at step S301, the update request unit 21 resets the number i of consecutive firmware update requests to “0.” At step S302, the update request unit 21 transfers the new piece of firmware to the update processing unit 11, and requests the update processing unit 11 to update the firmware. At step S303, the update request unit 21 increments the number i of consecutive requests by 1. Thereafter, steps S102 to S109 of FIG. 6 are performed.

If no error occurs during updating of the firmware, and therefore the error detection unit 22 has not detected an error (NO at step S304), steps S110 to S113 of FIG. 6 are performed, after which the process terminates. Thus, the updating of the firmware completes successfully.

Otherwise, if an error occurs during updating of the firmware, and the error detection unit 22 has detected the error (YES at step S304), steps S203 to S218 of FIG. 7 are performed to restart the MFP 100 at step S305. Not a that if the MFP 100 is configured similarly to the MFP 100 of the second embodiment, steps S203 to S218 and steps S222 to S227 of FIG. 10 may instead be performed.

After the MFP 100 restarts, at step S306, the update request unit 21 determines whether the number i of consecutive firmware update requests is greater than or equal to a preset maximum value I. The maximum value I may be set to any value.

If the number i of consecutive requests is less than the maximum value I (YES at step S306), the process returns to step S302, and the process at and after step S219 of FIG. 7 is performed.

Otherwise, if the number i of consecutive requests is greater than the maximum value I (NO at step S306), the process terminates. In this case, the firmware of the operation panel 1 is not updated.

As described above, the MFP 100 in this embodiment can limit the number i of consecutive requests to the maximum value I by counting the number i of consecutive requests made by the update request unit 21 to request the update processing unit 11 to update the firmware. Thus, when restarting of the MFP 100 cannot solve the error that has occurred during updating of the firmware, the number of restarts of the MFP 100 can be limited. This procedure can shorten a time duration during which the MFP 100 is unusable by a user due to a restart operation of the MFP 100.

As has been described above, the information processing system of each of the disclosed embodiments of the present disclosure can solve an error that has occurred during updating of software, and the software can thus be successfully updated.

It should be understood that the invention is not limited to the disclosed embodiments. Rather, the disclosure can be modified, for example, to incorporate other elements not heretofore described into the configuration described in any of the disclosed embodiments without departing from the spirit and scope of the invention. Such changes and modifications can be suitably made depending on specific applications.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Those skilled in the art will appreciate that the mechanism of at least portions of the present invention or aspects thereof are capable of being distributed in the form of a computer readable program product stored in a tangible computer medium and a computer readable medium of instructions in a variety of forms for execution on a processor, processors, or the like, and that the present invention applies equally regardless of the particular type of signal bearing media used to actually carry out the distribution.

Note, the computer readable program product can be in the form of microcode, programs, routines, and symbolic languages that provide a specific set or sets of ordered operations that control the functioning of the hardware and direct its operation, as known and understood by those skilled in the art. Examples of computer readable media include but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, HD-DVDs, mini disks, laser disks, Blu-ray disks, and other newer types of memories, and certain transmission type media such as digital and analog communication links capable of storing a computer readable program product according to various embodiments of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing system comprising:
a first information processing device; and
a second information processing device communicatively connected to the first information processing device,
the first information processing device including:
an update processing unit to perform updating of software; and
a first shutdown processing unit to perform shutting down of the first information processing device,
the second information processing device including:
an update request unit to request the update processing unit to perform the updating;
an error detection unit to detect an error during the updating;
a second shutdown processing unit to perform shutting down of the second information processing device;
a shutdown request unit to request the first shutdown processing unit and the second shutdown processing unit to perform the shutting down in response to a detection of the error with the error detection unit; and
a startup unit to start up the second information processing device at a predetermined time after the shutting down of the second information processing device.

2. The information processing system according to claim 1,
wherein the update request unit sets a flag indicating that the updating is in progress when the update request unit requests the updating, and clears the flag when the updating completes.

3. The information processing system according to claim 2,
wherein the update request unit checks whether the flag is set after the startup of the second information processing device, and if the flag is set, the update request unit requests the update processing unit to perform the updating.

4. The information processing system according to claim 1,
wherein the error detection unit determines that the error has occurred in at least one of:
a case in which the error detection unit periodically sends a query about progress of the updating to the update processing unit and receives no response to the query; and
a case in which the updating does not progress for a predetermined time period or more.

5. The information processing system according to claim 1,
wherein the first information processing device further includes a power-off unit to perform shutting down of the first information processing device at a predetermined time after the first shutdown processing unit starts the shutting down.

6. The information processing system according to claim 1,
wherein the update request unit determines not to request performing the updating if a number of consecutive requests for performing the updating is greater than or equal to a predetermined number.

7. An information processing method performed by a second information processing device communicatively connected to a first information processing device, the method comprising:
requesting the first information processing device to perform updating of software;
detecting an error during the updating;
requesting the first information processing device to perform shutting down in response to a detection of the error during the updating;
shutting down the second information processing device; and
starting up the second information processing device at a predetermined time after the shutting down of the second information processing device.

8. A computer program product comprising a non-transitory computer-readable medium containing program code, the program code causing a second information processing device communicatively connected to a first information processing device to perform:
requesting the first information processing device to perform updating of software;
detecting an error during the updating;
requesting the first information processing device to perform shutting down in response to a detection of the error during the updating;
shutting down the second information processing device; and
starting up the second information processing device at a predetermined time after the shutting down of the second information processing device.
